(19) United States
(12) Patent Application Publication
(10) Pub. No.: US 2025/0234373 A1
(43) Pub. Date: Jul. 17, 2025

(54) COORDINATION BETWEEN MULTIPLE ACCESS POINTS

(71) Applicant: Samsung Electronics Co., Ltd., Suwon-si, (KR)

(72) Inventors: Rubayet Shafin, Frisco, TX (US); Boon Loong Ng, Plano, TX (US); Yue Qi, Plano, TX (US); Peshal Nayak, Plano, TX (US); Vishnu Vardhan Ratnam, Plano, TX (US)

(21) Appl. No.: 19/006,068

(22) Filed: Dec. 30, 2024

Related U.S. Application Data
(60) Provisional application No. 63/620,593, filed on Jan. 12, 2024.

(51) Int. Cl. H04W 74/04; H04W 8/00; H04W 74/0816

(52) U.S. Cl. CPC H04W 74/04; H04W 8/005; H04W 74/0816

(57) ABSTRACT

A first access point (AP) participates in a multi-AP coordination for a first target wake time (TWT) schedule established by a second AP. The first AP advertises, to one or more stations (STAs) within a basic service set (BSS) of the first AP, a TWT schedule that is identical to the first TWT schedule established by the second AP. When a second TWT schedule is established by the second AP, the first AP advertises, to the one or more STAs within the BSS of the first AP, a TWT schedule that is identical to the second TWT schedule established by the second AP. Alternatively, when one or more second TWT schedules are established by the second AP, the first AP determines whether to advertise the one or more second TWT schedules on a per-TWT schedule basis.

### CROSS-REFERENCE TO RELATED APPLICATIONS

This application claims the benefit of priority from U.S. Provisional Application No. 63/620,593, entitled “COORDINATION BETWEEN MULTIPLE APS FOR TWT,” filed Jan. 12, 2024, which is incorporated herein by reference in its entirety.

### TECHNICAL FIELD

This disclosure relates generally to wireless communication systems, and more particularly to, for example, but not limited to, coordination between multiple access points (APs) in wireless communication systems.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides a first access point (AP) in a wireless network. The first AP device comprises a memory, and a processor coupled to the memory. The processor is configured to cause: participating in a multi-AP coordination for a first target wake time (TWT) schedule established by a second AP; and advertising, to one or more stations (STAs) within a basic service set (BSS) of the first AP, a TWT schedule that is identical to the first TWT schedule established by the second AP.

In some embodiments, the processor is further configured to cause: when a second TWT schedule is established by the second AP, advertising, to the one or more STAs within the BSS of the first AP, a TWT schedule that is identical to the second TWT schedule established by the second AP.

In some embodiments, the processor is further configured to cause: when one or more second TWT schedules are established by the second AP, determining whether to advertise the one or more second TWT schedules on a per-TWT schedule basis; and advertising, to the one or more STAs within the BSS of the first AP, one or more TWT schedules based on the determination.

In some embodiments, the TWT schedule is included in a TWT element, and the TWT element includes an indication that the TWT schedule is an overlapping basic service set (OBSS) TWT schedule.

In some embodiments, the TWT schedule is included in a TWT element, and the TWT element indicates a mode of multi-AP coordination and provides associated information for the mode of multi-AP coordination.

In some embodiments, the mode of multi-AP coordination is a coordinated time division multiple access (C-TDMA), and the TWT schedule advertised in the BSS of the first AP is synchronized with the first TWT schedule established by the second AP for C-TDMA operation across the BSS of the first AP and a BSS of the second AP.

In some embodiments, the processor is further configured to cause: receiving, from the second AP, a multi-AP coordination discovery frame that includes TWT information and capability information for a particular mode of multi-AP coordination; and transmitting, to the second AP, a multi-AP coordination discovery response frame that includes an indication on whether to participate in the multi-AP coordination.

In some embodiments, the processor is further configured to cause: receiving, from the second AP, a multi-AP coordination request frame that includes TWT schedule information and information associated with the particular mode of multi-AP coordination; and transmitting, to the second AP, a multi-AP coordination response frame that indicates whether the first AP agrees with the TWT information and information associated with the particular mode of multi-AP coordination included in the multi-AP coordination request frame.

An aspect of the disclosure provides a first access point (AP) in a wireless network. The first AP device comprises a memory, and a processor coupled to the memory. The processor is configured to cause: participating in a multi-AP coordination for a first target wake time (TWT) schedule with a second AP, the first TWT schedule being established by the first AP; providing, to the second AP, the first TWT schedule; and advertising, to one or more stations (STAs) within a basic service set (BSS) of the first AP, the first TWT schedule. A TWT schedule advertised within a BSS of the second AP is identical to the first TWT schedule.

In some embodiments, the TWT schedule is included in a TWT element, and the TWT element indicates a mode of multi-AP coordination and providing associated information for the mode of multi-AP coordination.

In some embodiments, the mode of multi-AP coordination is a coordinated time division multiple access (C-TDMA), and the first TWT schedule advertised in the BSS of the first AP is synchronized with the TWT schedule advertised by the second AP for C-TDMA operation across the BSS of the first AP and a BSS of the second AP.

In some embodiments, the processor is further configured to cause: transmitting, to the second AP, a multi-AP coordination discovery frame that includes TWT information and capability information for a particular mode of multi-AP coordination; and receiving, from the second AP, a multi-AP coordination discovery response frame that includes an indication on whether to participate in the multi-AP coordination.

In some embodiments, the processor is further configured to cause: transmitting, to the second AP, a multi-AP coordination request frame that includes TWT schedule information and information associated with the particular mode of multi-AP coordination; and receiving, from the second AP, a multi-AP coordination response frame that indicates whether the first AP agrees with the TWT information and information associated with the particular mode of multi-AP coordination included in the multi-AP coordination request frame.

An aspect of the disclosure provides a method performed by a first access point (AP) in a wireless network. The method comprises: participating in a multi-AP coordination for a first target wake time (TWT) schedule established by a second AP; and advertising, to one or more stations (STAs) within a basic service set (BSS) of the first AP, a TWT schedule that is identical to the first TWT schedule established by the second AP.

In some embodiments, the method further comprises: when a second TWT schedule is established by the second AP, advertising, to the one or more STAs within the BSS of the first AP, a TWT schedule that is identical to the second TWT schedule established by the second AP.

In some embodiments, the method further comprises: when one or more second TWT schedules are established by the second AP, determining whether to advertise the one or more second TWT schedules on a per-TWT schedule basis; and advertising, to the one or more STAs within the BSS of the first AP, one or more TWT schedules based on the determination.

In some embodiments, the TWT schedule is included in a TWT element, and the TWT element includes an indication that the TWT schedule is an overlapping basic service set (OBSS) TWT schedule.

In some embodiments, the TWT schedule is included in a TWT element, and the TWT element indicates a mode of multi-AP coordination and provides associated information for the mode of multi-AP coordination.

In some embodiments, the mode of multi-AP coordination is a coordinated time division multiple access (C-TDMA), and the TWT schedule advertised in the BSS of the first AP is synchronized with the first TWT schedule established by the second AP for C-TDMA operation across the BSS of the first AP and a BSS of the second AP.

In some embodiments, the method further comprises: receiving, from the second AP, a multi-AP coordination discovery frame that includes TWT information and capability information for a particular mode of multi-AP coordination; transmitting, to the second AP, a multi-AP coordination discovery response frame that includes an indication on whether to participate in the multi-AP coordination; receiving, from the second AP, a multi-AP coordination request frame that includes TWT schedule information and information associated with the particular mode of multi-AP coordination; and transmitting, to the second AP, a multi-AP coordination response frame that indicates whether the first AP agrees with the TWT information and information associated with the particular mode of multi-AP coordination included in the multi-AP coordination request frame.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example architecture for coordinated TWT (C-TWT) negotiation in accordance with an embodiment.

FIG. 5 shows another example architecture for C-TWT negotiation in accordance with an embodiment.

FIG. 6 shows example phases of TWT MAP coordination in accordance with an embodiment.

FIG. 7 shows an example R-TWT coordination in accordance with an embodiment.

FIG. 8 shows an example scenario of C-TDMA operation in the MAP coordination in accordance with an embodiment.

FIG. 9 shows an example of discovery frame exchanges for TWT-assisted C-TDMA mode MAP coordination in accordance with an embodiment.

FIG. 10 shows an example of negotiation frame exchanges for TWT-assisted C-TDMA mode MAP coordination in accordance with an embodiment.

FIG. 11 shows an example format of the TWT element in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

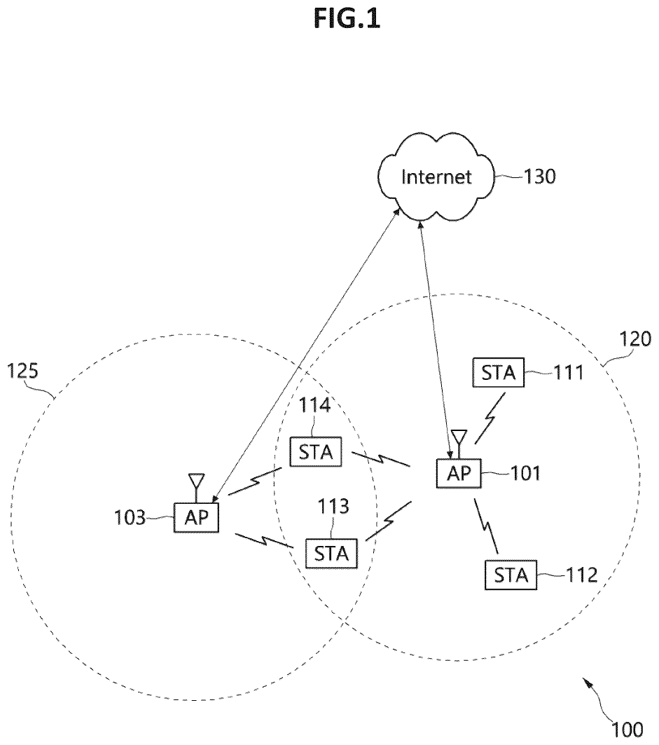

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

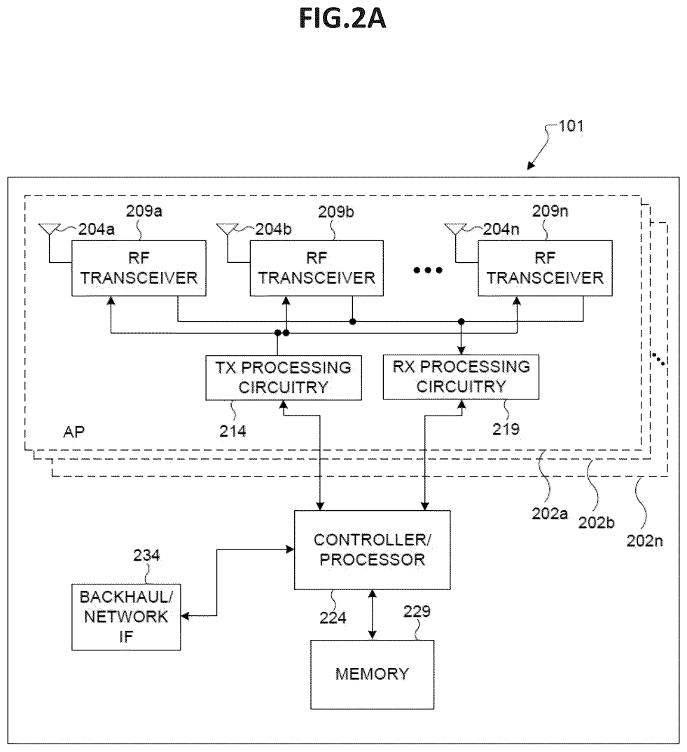

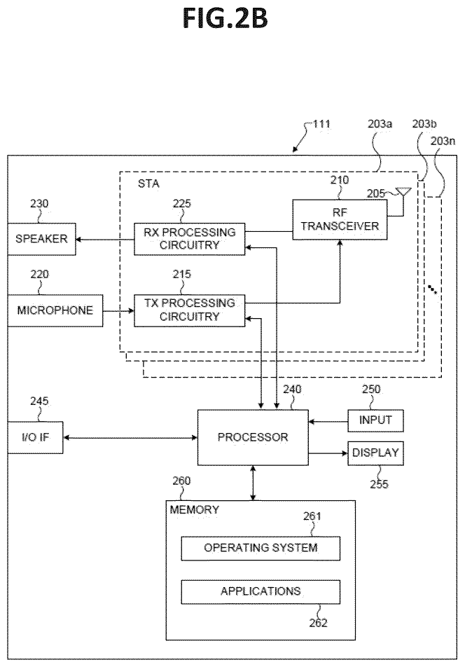

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

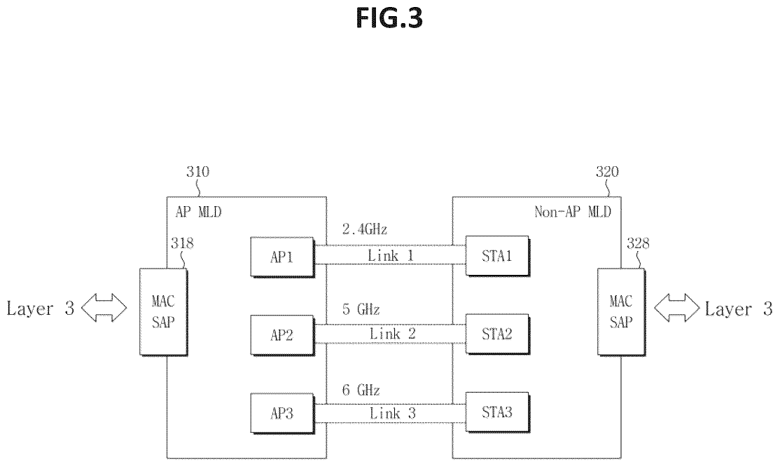

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.”

Target wake time (TWT) operation is a feature of power management in WLAN networks. The TWT operation enables an AP to manage activity in the basic service set (BSS) to minimize contention between STAs and reduce required wake times for STAs during the TWT operation. It may be achieved by allocating STAs to operate at non-overlapping times or frequencies and perform frame exchange sequences in pre-scheduled service periods. In the TWT operation, a STA can wake up at pre-scheduled times that have been negotiated with an AP or another STA in the BSS. The STA does not need to be aware of TWT parameter values of other STAs within the BSS or of STAs in other BSSs. The STA does not need to be aware that a TWT service period (SP) is used to exchange frames with other STAs. Frames transmitted during the TWT SP can employ any PPDU (physical layer protocol data unit) format supported by the pair of STAs that have established the corresponding TWT agreement, including, but not limited to, HE MU (high efficiency multi-user) PPDU, HE TB (high efficiency trigger based) PPDU.

IEEE 802.11 standard describes two types of TWT operations: individual TWT operation and broadcast TWT operation. In the individual TWT operation, an individual TWT agreement can be established between two STAs or between a STA and an AP. The negotiation for the individual TWT operation may occur between two STAs or between a STA and an AP on an individual basis. An AP may have TWT agreements with multiple STAs. Any changes in the TWT agreement between the AP and one STA do not affect the TWT agreement between the AP and other STAs.

On the other hand, the broadcast TWT operates in a membership-based approach. In broadcast TWT operation, an AP can set up a shared TWT session for a group of STAs. The AP is typically the controller of the broadcast TWT schedule. The non-AP STAs in the BSS can request membership in the broadcast TWT schedule, or the AP can send unsolicited response to a STA to make the STA a member of the broadcast TWT schedule that the AP maintains in the BSS. The AP may advertise and maintain multiple broadcast TWT schedules in the BSS. When a change is made to any broadcast TWT schedules in the BSS, it may affect all or some of STAs that are members of the corresponding broadcast TWT schedule.

As discussed above, the multi-link operation (MLO) is a key feature for the next generation WLAN. Devices that support the MLO may be referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

TWT enhancements for multi-link devices have recently been discussed in various ways. For example, for individual TWT agreements between two MLDs, a STA affiliated with an MLD, which is a TWT requesting STA, may indicate one or more links that are requested for setting up TWT agreements in the Link ID bitmap subfield of a TWT element in the TWT request. If only one link is indicated in the Link ID bitmap subfield of the TWT element, a single TWT agreement is requested for the STA affiliated with the same MLD, which is operating on the indicated link. A Target Wake Time field of the TWT element may be in reference to the TSF time of the link indicated by the TWT element. Then, a TWT responding STA affiliated with a peer MLD that receives the TWT request including the Link ID bitmap subfield responds with a TWT response indicating one or more links in the Link ID bitmap subfield in the TWT element. The one or more links in the TWT element carried in the TWT response may be the same as the one or more links in the TWT element carried in the TWT response.

Restricted TWT (R-TWT) operation is another important feature for the next generation WLAN. The R-TWT operation provides better support for latency sensitive applications. For instance, traffic in real time applications has stringent requirements in terms of latency and jitter along with certain reliability constraints. Such traffic may be referred to as latency sensitive traffic in this disclosure. The R-TWT operation may offer a protected service period (SP) for R-TWT member STAs by sending Quiet elements to non-member STAs in the BSS in the R-TWT schedule. In some implementations, a quiet interval of the Quiet element overlaps with the initial portion of the R-TWT SP. Therefore, it may provide greater channel access opportunities to R-TWT member STAs than non-member STAs, thereby improving the flow of latency sensitive traffic.

Interference from one BSS may often lead to performance issues for STAs and APs in neighboring BSSs. This interference may result in overall throughput degradation in the network. The Overlapping BSS (OBSS) interference may also increase the overall latency since it takes more time to access the channel due to the interference occupying the channel. If a STA in a BSS has latency-sensitive traffic, this delay in channel access may significantly impede the performance of the STA's latency-sensitive applications. TWT-based multi-AP (MAP) coordination can be an important feature for the next generation WLAN.

In an embodiment, a first AP may coordinate with a second AP in the vicinity in order to coordinate with the AP's individual TWT agreement, a broadcast TWT schedule, or R-TWT schedule. The coordination mechanism may take different formats based on the architecture of a coordinated TWT (C-TWT) negotiation.

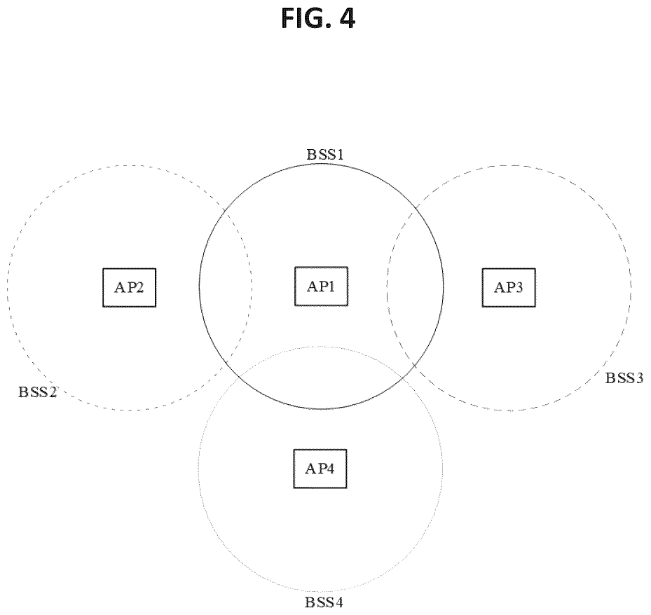

FIG. 4 shows an example architecture for C-TWT negotiation in accordance with an embodiment.

In FIG. 4, AP 1, AP 2, AP 3, and AP 4 establish BSS 1, BSS2, BSS 3, and BSS4, respectively. Additionally, AP 1, AP 2, AP 3, and AP 4 are members of a TWT coordination AP set and are participating in a TWT-based MAP coordination (or TWT MAP coordination). In FIG. 4, the APs may be TWT scheduling APs in their BSSs. In this disclosure, the TWT scheduling AP is an AP that schedules broadcast TWTs and provides these broadcast TWT schedules in a broadcast TWT element. The TWT scheduled STA is a STA that follows the broadcast TWT schedules provided in a broadcast TWT element. The APs participating in the TWT MAP coordination may directly exchange frames among the APs to negotiate the TWT MAP coordination. This topology may be referred to as ‘Type-1 architecture for coordinated TWT (C-TWT) negotiation’ in this disclosure.

In an embodiment, negotiations between APs for TWT MAP coordination may be controlled by a controller, for example, a TWT central controller.

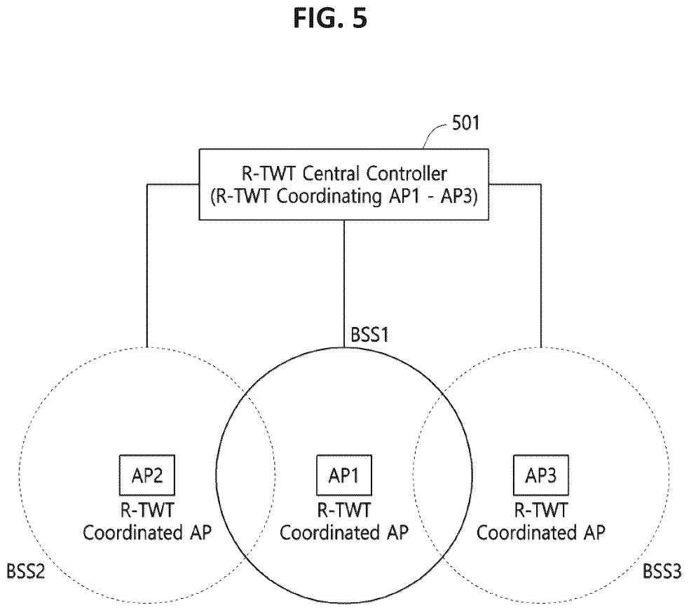

FIG. 5 shows another example architecture for C-TWT negotiation in accordance with an embodiment.

In FIG. 5, AP 1, AP 2, and AP 3 establishes BSS 1, BSS 2, and BSS 3, respectively. All three APs are connected to a TWT central controller 501. The TWT central controller 501 coordinates AP1, AP 2, and AP 3 for C-TWT negotiation, and AP 1, AP2, and AP 3 serve as R-TWT coordinated APs. In the example of FIG. 5, the APs support the R-TWT operation to protect latency sensitive traffic. This topology may be referred to as ‘Type-2 architecture for C-TWT negotiation’ in this disclosure.

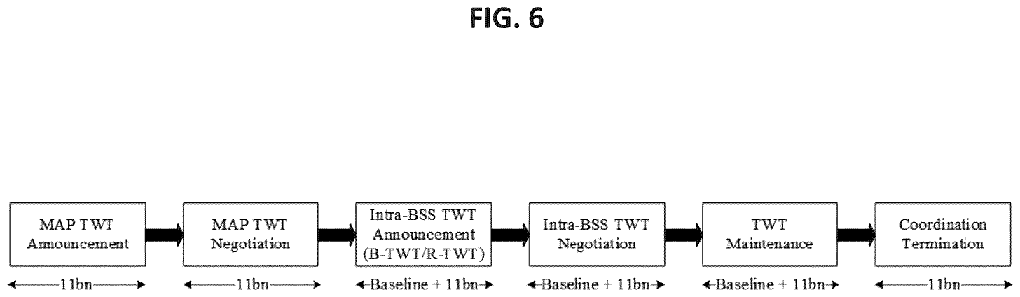

FIG. 6 shows example phases of TWT MAP coordination in accordance with an embodiment.

As shown in FIG. 6, the TWT MAP coordination may include the following phases: i) an MAP TWT Announcement, ii) an MAP TWT negotiation, iii) an Intra-BSS TWT Announcement (broadcast TWT or R-TWT), iv) an Intra-BSS TWT negotiation, v) a TWT maintenance, and vi) a TWT coordination termination. The MAP TWT Announcement, the MAP TWT negotiation, and the TWT coordination termination may be specified in IEEE 802.11bn standard (“11bn” standard), and the Intra-BSS TWT Announcement, the Intra-BSS TWT negotiation, and the TWT maintenance may be specified in IEEE 802.11bn standard and the preexisting IEEE 802.11 standard (“Baseline” standard).

The conventional WLAN system lacks clarity regarding the coordination mechanisms between two or more APs for R-TWT operations. Furthermore, it is unclear how existing signaling methods can be utilized for R-TWT coordination in next-generation WLAN systems. Additionally, the integration of TWT coordination with other types of MAP coordination remains unclear.

The present disclosure provides various embodiments of TWT MAP coordination. Furthermore, the disclosure provides various embodiments on how existing signaling for R-TWT coordination can be utilized for the next-generation WLAN systems. Additionally, the disclosure provides various embodiments on how TWT coordination can be integrated with other types of MAP coordination.

In some embodiments, a first AP participating in the MAP coordination for R-TWT with a second AP adheres to the R-TWT rules during the R-TWT SPs based on an R-TWT schedule established by the second AP.

In some embodiments, the second AP establishes an R-TWT schedule in its BSS. When the first AP agrees to participate in the MAP coordination for R-TWT with a second AP, the first AP advertises the same R-TWT schedule as the R-TWT schedule established by the second AP in the BSS of the first AP.

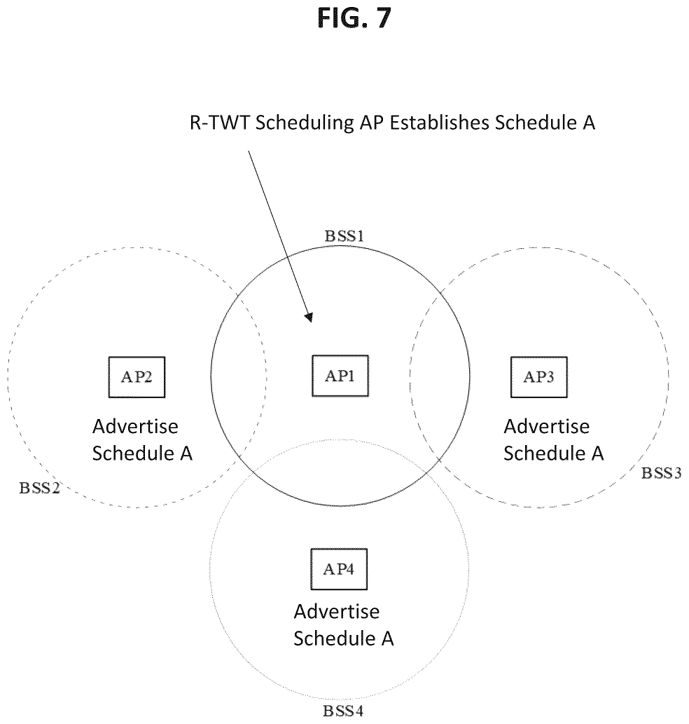

FIG. 7 shows an example R-TWT coordination in accordance with an embodiment. The example depicted in FIG. 7 is based on the ‘Type-1 architecture for C-TWT negotiation’ described in FIG. 4.

Referring to FIG. 7, AP 2, AP 3, and AP 4 participate in the R-TWT MAP coordination for AP 1. AP 1 establishes an R-TWT schedule (“Schedule A”) in BSS 1, and AP 2, AP 3, and AP 4 advertise the R-TWT schedule in their respective BSSs. Furthermore, when AP 1 subsequently establishes another R-TWT schedule (“Schedule B”) in BSS 1, AP 2, AP 3, and AP 4 advertises the R-TWT schedule (“Schedule B”) in their respective BSSs. In this disclosure, this type of R-TWT MAP coordination may be referred to as “All R-TWT coordination.” In this All R-TWT coordination, a successful R-TWT coordination agreement between APs may imply that all participating APs (AP 2, AP 3, and AP 4 in FIG. 7) adhere to and observe all the R-TWT schedules established by the R-TWT scheduling AP (AP 1 in FIG. 7).

In some embodiments, when a first AP establishes a first R-TWT schedule in its BSS and the second AP agrees to participate in R-TWT MAP coordination with the first AP, the second AP may follow and advertise the first R-TWT schedule in its BSS. However, the second AP may not advertise and establish another R-TWT schedule (a second R-TWT schedule) established by the first AP. In this disclosure, this type of R-TWT MAP coordination may be referred to as “Specific R-TWT coordination.” In the Specific R-TWT coordination, the R-TWT MAP coordination may be determined on a per-schedule basis. Agreement to follow or observe the rules for the first R-TWT schedule established by a first AP may not imply agreement to follow a second R-TWT schedule established by the first AP.

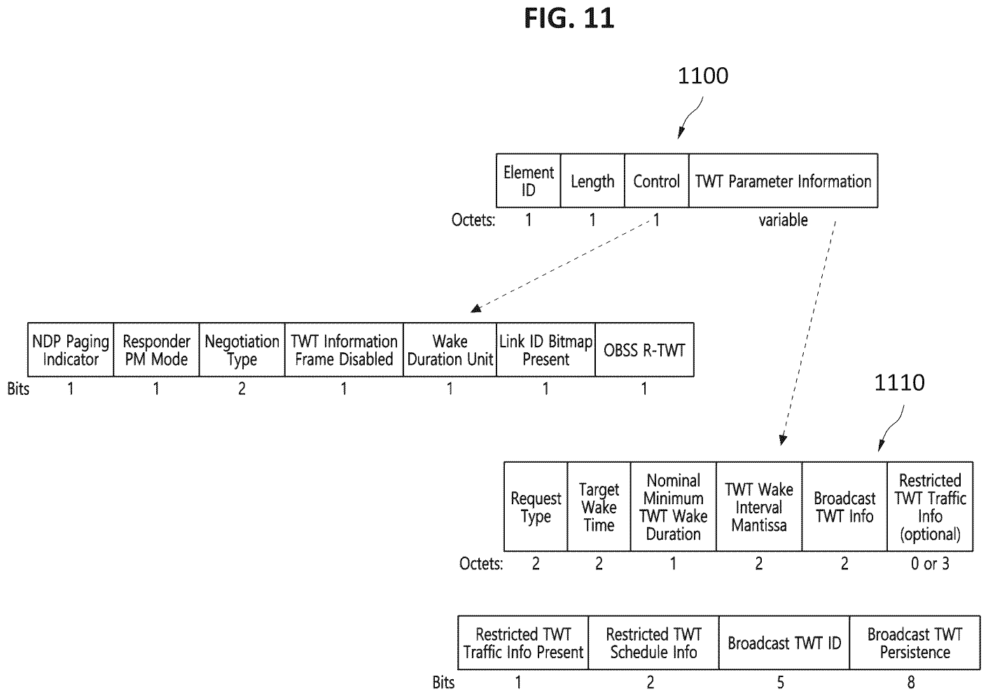

In some embodiments, when a first AP and a second AP agree to coordinate on a first R-TWT schedule established by the first AP, the second AP may advertise an R-TWT schedule in its BSS by including a corresponding TWT element in a beacon frame or a probe response frame. In the TWT element, the second AP may indicate that the corresponding R-TWT schedule is an overlapping basic service set (OBSS) schedule. In an embodiment, the second AP indicates in the TWT element that the R-TWT schedule is established by the first AP. The indication may be implemented by setting a value representing the OBSS schedule indication in the R-TWT schedule Info subfield in the broadcast TWT info subfield of the TWT element, which is depicted in FIG. 11.

In some embodiments, when a first AP and a second AP agree to coordinate on a first R-TWT schedule established by the first AP, the second AP may advertise an R-TWT schedule in its BSS by including a corresponding TWT element in a beacon frame or a probe response frame. In the TWT element, the second AP may indicate that the corresponding R-TWT schedule is open for membership for the STAs associated with the second AP. This indication may be implemented by setting an empty TWT schedule indication value in the R-TWT Schedule Info subfield in the broadcast TWT Info subfield of the TWT element. Alternatively, the indication may be made by setting an active TWT schedule indication value in the R-TWT Schedule Info subfield in the broadcast TWT Info subfield of the TWT element.

In some embodiments, a first AP and a second AP may share TWT information (e.g., a set of TWT parameters) by exchanging a TWT element. The TWT information may be used to indicate a TWT service period of various types of MAP coordination, such as a coordinated beamforming, a coordinated spatial reuse (C-SR), a joint transmission, and a coordinated time division multiple access (TDMA). Additional information may be shared between APs to indicate the types of MAP coordination to be used during the service periods, as defined by the TWT element corresponding to the TWT information.

In some embodiments, when two APs exchange TWT information for a type of MAP coordination, they may also include additional parameters related to the specific type of MAP coordination. For example, when TWT SPs are used for a time window for C-SR, a set of parameters related to C-SR may also be exchanged between the APs.

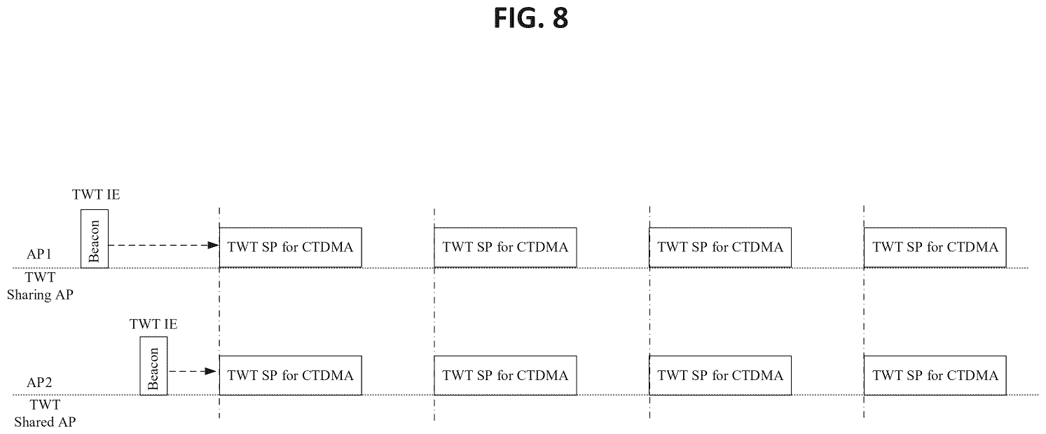

FIG. 8 shows an example scenario of C-TDMA operation in the MAP coordination in accordance with an embodiment.

In this example, two APs negotiate a TWT-based time schedule for coordination on C-TDMA. The C-TDMA procedure may begin at the start of a TWT SP corresponding to the TWT schedule negotiated between the two APs. In this example, TWT SPs may serve as a mechanism to synchronize the C-TDMA operation across the two BSSs controlled by the APs participating in the MAP coordination for C-TDMA. In an embodiment, the TWT schedule may be an R-TWT schedule.

Referring to FIG. 8, AP 1 is a TWT sharing AP, and AP 2 is a TWT shared AP. AP 1 and AP 2 agree to coordinate on TWT schedules established by AP 1. AP 1 advertises its established TWT schedule in its BSS by transmitting a beacon frame 801 to its associated STAs. AP 2 also advertises the TWT schedule established by the AP 1 in its BSS by transmitting a beacon frame 803 to its associated STAs. The TWT schedule indicates a TWT SP schedule for C-TDMA. The TWT SPs in AP 1's BSS are aligned or synchronized with the TWT SPs in AP 2's BSS. Accordingly, the synchronized TWT SPs in both AP 1's BSS and AP 2's BSS enable AP 1 and AP 2 to perform the C-TDMA operation across the two BSSs controlled by AP 1 and AP 2.

In some embodiments, a first AP intends to coordinate with a second AP on a particular mode of MAP coordination where TWT or R-TWT is used for timing guidance for the mode of MAP coordination. When the first AP intends to discover the second AP, the first AP may include capability information for both the C-TWT and the mode of MAP coordination in a MAP discovery frame. In the MAP discovery frame, the first AP includes the capability information for the MAP discovery. The first AP may include capability information in a beacon frame or a probe response frame. The discovery frame may be a broadcast frame or a multicast frame.

In some embodiments, a first AP receives a discovery frame from a second AP that indicates a MAP coordination using a coordinated R-TWT as a synchronization tool. When the first AP intends to participate in the MAP coordination with the second, the first AP may send a management frame or an action frame to the second AP, indicating that the first AP is interested in participating in an intended mode of the MAP coordination.

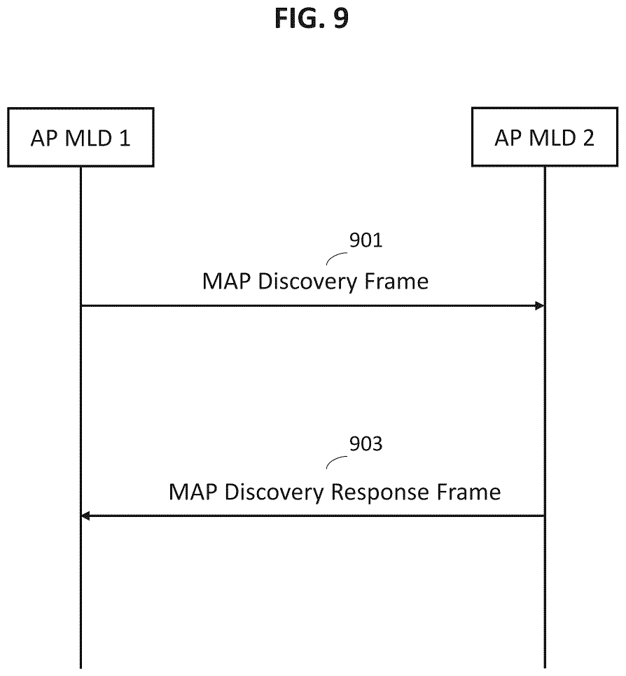

FIG. 9 shows an example of discovery frame exchanges for TWT-assisted C-TDMA mode MAP coordination in accordance with an embodiment.

Referring to FIG. 9, AP MLD 1 intends to coordinate with AP MLD 2 on a C-TDMA mode MAP coordination. AP MLD 1 sends a MAP discovery frame 901 to AP MLD 2. The MAP discovery frame 901 may be included in a beacon frame or a probe response frame. The MAP discovery frame may include R-TWT information and C-TDMA capability information.

In response, AP MLD 2 sends a MAP discovery response frame 903 to AP MLD 1. The MAP discovery response frame 903 may be an individually addressed management frame. The MAP discovery response frame 903 may include R-TWT information and C-TDMA capability information. Furthermore, the MAP discovery response frame 903 may include an indication of intention to participate in the TWT-assisted C-TDMA mode MAP coordination.

In some embodiments, a first AP discovers a second AP for MAP coordination where TWT or R-TWT is used for timing guidance for a particular mode MAP coordination. When the second AP indicates the intention to participate in the MAP coordination with the first AP, the first AP may subsequently send a MAP coordination (MAP-C) negotiation request frame to the second AP. In the MAP-C negotiation request frame, the first AP may include detailed TWT schedule information along with detailed information about a particular mode MAP coordination. In an aspect, when the intended mode of MAP coordination is C-TDMA where TWT information is used to harmonize or synchronize the timing of the C-TDMA operation, both TWT information and C-TDMA information may be carried in the MAP-C negotiation request frame. In an embodiment, to convey the TWT information used for the MAP coordination, the TWT element may be included in the MAP-C negotiation request frame. The TWT element may include one or more TWT parameter sets. Each TWT parameter set may indicate a particular TWT schedule. In another embodiment, instead of including the entire TWT element, only the information included in a particular TWT parameter sets field within the TWT element may be included in the MAP-C negotiation request frame.

In some embodiments, a first AP discovers a second AP for a particular mode MAP coordination and receives a MAP-C negotiation request frame from the second AP. The MAP-C negotiation request frame may indicate a TWT-assisted MAP coordination. Subsequently, the first AP may send a MAP-C negotiation response frame to the second AP. The MAP-C negotiation response frame may indicate whether the first AP agrees to a set of parameters for negotiation indicated in the MAP-C negotiation request frame. In response, if the first AP agrees to the set of parameters for negotiation, the first AP may include the same set of parameters in a MAP-C negotiation response frame, such as TWT parameters and the parameters corresponding to the other MAP coordination mechanism, suggested by the second AP in the MAP-C negotiation request frame.

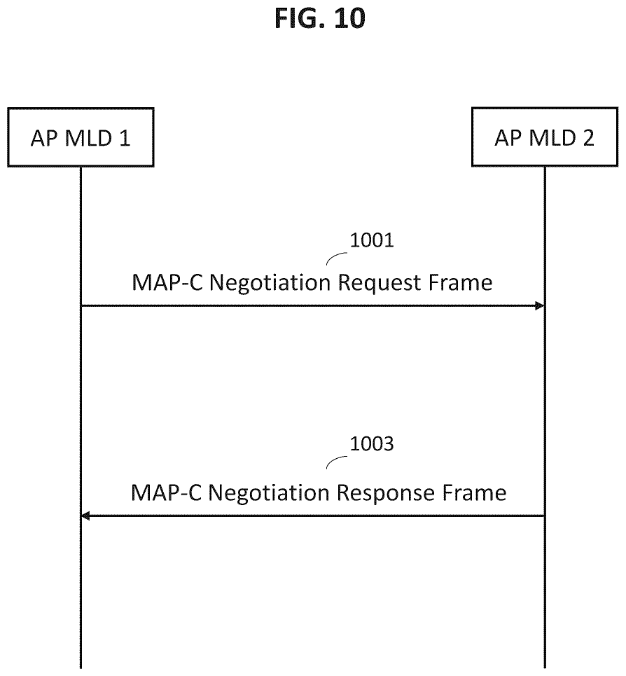

FIG. 10 shows an example of negotiation frame exchanges for TWT-assisted C-TDMA mode MAP coordination in accordance with an embodiment.

Prior to the operations depicted in FIG. 10, AP MLD 1 discovers AP MLD 2 for MAP coordination for TWT-assisted C-TDMA mode MAP coordination. Also, AP MLD 2 indicates its intention to participate in the TWT-assisted C-TDMA mode MAP coordination.

Then, referring to FIG. 10, AP MLD 1 send a MAP-C negotiation request frame 1001 to AP MLD 2. The MAP-C negotiation request frame 1001 may be an individually addressed management frame. The MAP-C negotiation request frame 1001 may include R-TWT information as well as detailed C-TDMA information.

In response, AP MLD 2 sends a MAP-C negotiation response frame 1003 to AP MLD 1. The MAP-C negotiation response frame 1003 may be an individually addressed management frame. The MAP-C negotiation response frame 1003 may include R-TWT information as well as detailed C-TDMA information, which is a response to the suggested R-TWT information and C-TDMA information included in the MAP-C negotiation request frame 1001. The MAP-C negotiation response frame 1003 may include an indication of the acceptance or rejection to the suggestion in the MAP-C negotiation request frame 1001. In an embodiment, if AP MLD 2 agrees to a set of parameters suggested in the MAP-C negotiation request frame 1001, AP MLD 2 may include the same TWT parameters suggested by AP MLD 1 in the MAP-C negotiation request frame 1001.

FIG. 11 shows an example format of the TWT element in accordance with an embodiment.

In FIG. 11, the TWT element 1100 may include an Element identifier (ID) field, a length field, a Control field, and a TWT Parameter Information field. The Element ID field may include information to identify the TWT element 1100. The Length field may indicate a length of the TWT element 1100.

The Control field may include a null data PPDU (physical layer protocol data unit) (NDP) Paging Indicator subfield, a Responder power management (PM) Mode subfield, a Negotiation Type subfield, a TWT Information Frame Disabled subfield, a Wake Duration Unit subfield, a Link ID Bitmap Present subfield, and an OBSS R-TWT subfield. The NDP Paging Indicator subfield may indicate whether an NDP paging field is present or not in an Individual TWT Parameter Set field. The Responder PM Mode subfield may indicate the power management mode, such as active mode and power save (PS) mode. The negotiation Type subfield may indicate whether the information included in the TWT element is for the negotiation of parameters of broadcast or individual TWT or Wake TBTT (target beacon transmission time) interval. The MSB (most significant bit) of the Negotiation Type subfield is the Broadcast field which indicates if one or more Broadcast TWT Parameter Sets are contained in the TWT element. The TWT Information Frame Disabled subfield may indicate whether the reception of TWT information frame is disabled by the STA. The Wake Duration Unit subfield may indicate the unit of the Nominal Minimum TWT Wake Duration subfield in the Broadcast TWT Parameter Set field. The Link ID Bitmap Present subfield may indicate the presence of the Link ID Bitmap field in the Individual TWT Parameter Set field. The OBSS R-TWT subfield may indicate whether the R-TWT schedules corresponding to the Broadcast TWT Parameter Set fields in the TWT element are the R-TWT schedule of the neighboring BSS. When the OBSS R-TWT subfield is set to ‘1’, it may indicate that the R-TWT schedules in the TWT element are the R-TWT schedule of the neighboring BSS. Otherwise, it indicates that there is no neighboring BSS's R-TWT schedule in the TWT element.

The TWT Parameter information field includes an individual TWT parameter set field or one or more Broadcast TWT Parameter Set fields. For the convenience of description, FIG. 11 illustrates the Broadcast TWT Parameter Set fields. The Broadcast TWT Parameter Set field 1110 may include a Request Type field, a Target Wake Time field, a Nominal Minimum TWT Wake Duration field, a TWT Wake Interval Mantissa field, a Broadcast TWT Info (Information) field, and an optional Restricted TWT traffic Info field. The Request Type field includes information of the TWT element. The Target Wake Time field may include an unsigned integer corresponding to a TSF (time synchronization function) time for the TWT scheduled STA to wake up. The Target Wake Time field may indicate the start time of the TWT service period (SP) on the corresponding link. The Nominal Minimum TWT Wake Duration field may indicate the minimum amount of time that the TWT scheduled STA is expected to be awake in order to complete the frame exchanges for the period of TWT wake interval. The TWT wake interval is the average time that the TWT scheduled STA expects to elapse between successive TWT SPs. The TWT Wake Interval Mantissa field may indicate the value of the mantissa of the TWT wake interval value. The Broadcast TWT Info field may include information related to the broadcast TWT, such as a restricted TWT traffic info present field, a restricted TWT schedule info field, a Broadcast TWT ID field and a Broadcast TWT Persistence field. The restricted TWT traffic info present field indicates whether the restricted TWT traffic info field is present. The restricted TWT schedule info field indicates whether an active R-TWT schedule is active. In an embodiment, an AP may indicate that a corresponding R-TWT schedule is an overlapping basic service set (OBSS) schedule by setting a value representing the OBSS schedule indication in the R-TWT schedule Info subfield in the broadcast TWT info subfield of the TWT element. In an embodiment, an AP may indicate that a corresponding R-TWT schedule is open for membership for the STAs associated with the AP by setting an empty TWT schedule indication value in the R-TWT Schedule Info subfield in the broadcast TWT Info subfield of the TWT element. In an embodiment, an AP may indicate that a corresponding R-TWT schedule is open for membership for the STAs associated with the AP by setting an active TWT schedule indication value in the R-TWT Schedule Info subfield in the broadcast TWT Info subfield of the TWT element. The Broadcast TWT ID field indicates a specific broadcast TWT for which the transmitting STA is providing TWT parameters. The Broadcast TWT persistence field indicates the number of TBTTs during which the Broadcast TWT SPs corresponding to this broadcast TWT parameter set are present. In some embodiments, the Broadcast TWT persistence field may provide a parameter indicating a time when the updated TWT parameter set corresponding to the updated TWT schedule will be effective.

The disclosure presents various embodiments for signaling and establishing R-TWT coordination applicable to the next-generation WLAN systems. Additionally, the disclosure provides a solution to integrate TWT coordination with other types of MAP coordination.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of”' does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first access point (AP) in a wireless network, the first AP device comprising:
a memory; and
a processor coupled to the memory, the processor configured to cause:
participating in a multi-AP coordination for a first target wake time (TWT) schedule established by a second AP; and
advertising, to one or more stations (STAs) within a basic service set (BSS) of the first AP, a TWT schedule that is identical to the first TWT schedule established by the second AP.

2. The first AP of claim 1, wherein the processor is further configured to cause:
when a second TWT schedule is established by the second AP, advertising, to the one or more STAs within the BSS of the first AP, a TWT schedule that is identical to the second TWT schedule established by the second AP.

3. The first AP of claim 1, wherein the processor is further configured to cause:
when one or more second TWT schedules are established by the second AP, determining whether to advertise the one or more second TWT schedules on a per-TWT schedule basis; and
advertising, to the one or more STAs within the BSS of the first AP, one or more TWT schedules based on the determination.

4. The first AP of claim 1, wherein the TWT schedule is included in a TWT element, the TWT element including an indication that the TWT schedule is an overlapping basic service set (OBSS) TWT schedule.

5. The first AP of claim 1, wherein the TWT schedule is included in a TWT element, the TWT element indicating a mode of multi-AP coordination and providing associated information for the mode of multi-AP coordination.

6. The first AP of claim 5, wherein:
the mode of multi-AP coordination is a coordinated time division multiple access (C-TDMA); and
the TWT schedule advertised in the BSS of the first AP is synchronized with the first TWT schedule established by the second AP for C-TDMA operation across the BSS of the first AP and a BSS of the second AP.

7. The first AP of claim 1, wherein the processor is further configured to cause:
receiving, from the second AP, a multi-AP coordination discovery frame that includes TWT information and capability information for a particular mode of multi-AP coordination; and
transmitting, to the second AP, a multi-AP coordination discovery response frame that includes an indication on whether to participate in the multi-AP coordination.

8. The first AP of claim 7, wherein the processor is further configured to cause:
receiving, from the second AP, a multi-AP coordination request frame that includes TWT schedule information and information associated with the particular mode of multi-AP coordination; and
transmitting, to the second AP, a multi-AP coordination response frame that indicates whether the first AP agrees with the TWT information and information associated with the particular mode of multi-AP coordination included in the multi-AP coordination request frame.

9. A first access point (AP) in a wireless network, the first AP device comprising:
a memory; and
a processor coupled to the memory, the processor configured to cause:
participating in a multi-AP coordination for a first target wake time (TWT) schedule with a second AP, the first TWT schedule being established by the first AP;
providing, to the second AP, the first TWT schedule; and
advertising, to one or more stations (STAs) within a basic service set (BSS) of the first AP, the first TWT schedule,
wherein a TWT schedule advertised within a BSS of the second AP is identical to the first TWT schedule.

10. The first AP of claim 9, wherein the TWT schedule is included in a TWT element, the TWT element indicating a mode of multi-AP coordination and providing associated information for the mode of multi-AP coordination.

11. The first AP of claim 10, wherein:
the mode of multi-AP coordination is a coordinated time division multiple access (C-TDMA); and
the first TWT schedule advertised in the BSS of the first AP is synchronized with the TWT schedule advertised by the second AP for C-TDMA operation across the BSS of the first AP and a BSS of the second AP.

12. The first AP of claim 9, wherein the processor is further configured to cause:
transmitting, to the second AP, a multi-AP coordination discovery frame that includes TWT information and capability information for a particular mode of multi-AP coordination; and
receiving, from the second AP, a multi-AP coordination discovery response frame that includes an indication on whether to participate in the multi-AP coordination.

13. The first AP of claim 12, wherein the processor is further configured to cause:
transmitting, to the second AP, a multi-AP coordination request frame that includes TWT schedule information and information associated with the particular mode of multi-AP coordination; and
receiving, from the second AP, a multi-AP coordination response frame that indicates whether the first AP agrees with the TWT information and information associated with the particular mode of multi-AP coordination included in the multi-AP coordination request frame.

14. A method performed by a first access point (AP) in a wireless network, the method comprising:
participating in a multi-AP coordination for a first target wake time (TWT) schedule established by a second AP; and
advertising, to one or more stations (STAs) within a basic service set (BSS) of the first AP, a TWT schedule that is identical to the first TWT schedule established by the second AP.

15. The method of claim 14, further comprising:
when a second TWT schedule is established by the second AP, advertising, to the one or more STAs within the BSS of the first AP, a TWT schedule that is identical to the second TWT schedule established by the second AP.

16. The method of claim 14, further comprising:
when one or more second TWT schedules are established by the second AP, determining whether to advertise the one or more second TWT schedules on a per-TWT schedule basis; and
advertising, to the one or more STAs within the BSS of the first AP, one or more TWT schedules based on the determination.

17. The method of claim 14, wherein the TWT schedule is included in a TWT element, the TWT element including an indication that the TWT schedule is an overlapping basic service set (OBSS) TWT schedule.

18. The method of claim 14, wherein the TWT schedule is included in a TWT element, the TWT element indicating a mode of multi-AP coordination and providing associated information for the mode of multi-AP coordination.

19. The method of claim 14, wherein:
the mode of multi-AP coordination is a coordinated time division multiple access (C-TDMA); and
the TWT schedule advertised in the BSS of the first AP is synchronized with the first TWT schedule established by the second AP for C-TDMA operation across the BSS of the first AP and a BSS of the second AP.

20. The method of claim 14, further comprising:
receiving, from the second AP, a multi-AP coordination discovery frame that includes TWT information and capability information for a particular mode of multi-AP coordination;
transmitting, to the second AP, a multi-AP coordination discovery response frame that includes an indication on whether to participate in the multi-AP coordination;
receiving, from the second AP, a multi-AP coordination request frame that includes TWT schedule information and information associated with the particular mode of multi-AP coordination; and
transmitting, to the second AP, a multi-AP coordination response frame that indicates whether the first AP agrees with the TWT information and information associated with the particular mode of multi-AP coordination included in the multi-AP coordination request frame.
